(19) United States
(12) Patent Application Publication
(10) Pub. No.: US 2010/0028572 A1
(43) Pub. Date: Feb. 4, 2010

(54) Corrosion-resistant member and process for producing the same

(75) Inventors: Toshio Kobayashi, Osaka (JP); Yoshimi Morikawa, Osaka (JP); Koichiro Takayanagi, Chiba (JP)

Correspondence Address: WENDEROTH, LIND & PONACK, L.L.P., 1030 15th Street, N.W.,, Suite 400 East, Washington, DC, 20005-1503, US

(73) Assignee: Asahi Tech Co., Ltd., Osaka (JP)

(21) Appl. No.: 12/311,524

(22) PCT Filed: Oct. 2, 2007
(86) PCT No.: PCT/JP2007/069312

§ 371 Date: Apr. 2, 2009

(30) Foreign Application Priority Data
Oct. 6, 2006 (JP) 2006-275566

(51) Int. Cl. B32B 1/08; C04B 35/00; C22C 29/00; C04B 35/50; C03C 3/00; B32B 3/10

(52) U.S. Cl. 428/34.1; 420/578; 501/153; 501/152; 501/11; 428/131

(57) ABSTRACT

A corrosion-resistant member having a high acid resistance, plasma resistance, and hydrophilicity and a process for producing the corrosion-resistant member are provided. The corrosion-resistant member is obtained by surface-treating an untreated member (a ceramic, a metal) to a surface-treatment with a spray of a superheated water vapor having a temperature of 300 to 1000° C. The corrosion-resistant member may be a member contacting with a processing space in a vapor phase surface process apparatus (e.g., a chamber) for the surface process of a substrate by a vapor phase method such as a PVD, a CVD, or a dry etching.

### TECHNICAL FIELD

This invention relates to a corrosion-resistant member having a high acid resistance, plasma resistance, and hydrophilicity, for example, a corrosion-resistant member (or a modified member) which is useful as a member constituting an apparatus (for example, a display device constituting, e.g., a semiconductor manufacturing apparatus and a liquid crystal display manufacturing apparatus for a surface fabrication or surface process (such as a microfabrication or a thin-film processing or lithography) of base materials or substrates) and maintains the acid resistance and plasma resistance over a long period of time. Such an apparatus employs a vapor phase method (or gas phase process) for the surface fabrication or surface process of base materials or substrates. The invention also relates to a process for producing the corrosion-resistant member, a process for surface-treating (or surface-modifying) a member, and a surface-treated member (or a surface-modified member) obtained by the surface-treating (or the surface-modifying) process.

### BACKGROUND ART

In a microfabrication or a thin-film processing or lithographic technique of a semiconductor and a liquid crystal display device or the like, a base material or a substrate is subjected to a surface process utilizing a vapor phase method such as a physical vapor deposition, a chemical vapor deposition, or an etching. In a space of the apparatus for the vapor phase surface process, particles (organic or inorganic scattering particles such as particles for depositing on the base material or substrate) that may be accelerated or ionized are floated. Such particles adhere to the inner surface of the apparatus, so that the apparatus is contaminated with the particles. For example, an observation or an inspection window (e.g., a window for detecting an end point by sensor and a window for detecting an end point) of a dry etching apparatus, comprising a transparent member such as a quartz glass, is contaminated with a layer (e.g., an aluminum chloride layer, a resist layer, and a fluorine layer) of the floating (or the dispersing) particles, with proceeding dry etching. Such a layer on the window hinders observations of the inside of the apparatus. For reuse of the observation window (the quartz glass) of the apparatus, the window is regularly washed and polished to regenerate (or regain or reform) the surface smoothness and the transmittance. Accordingly, whenever the observation window (the quartz glass) is contaminated, it is necessary to regenerate the smoothness and the transmittance of the window with maintenance work for washing the surface. This greatly decreases the productivity of the apparatus.

Moreover, a protective cover made of glass for a solar cell (or solar battery) or a glass to be exposed to outdoor weather (including a window and a windshield or the like of a vehicle such as an automobile) is corroded due to an exposure to acid rain. Additionally, the protective cover mentioned above is contaminated or stained due to an adhesion of a dust or dirt. Therefore, the protective cover or the glass fails to maintain a high transparency over a long period of time. In addition, in the case of an optical member such as a lens or a photomask, it is necessary that an adhesion of dust or dirt to the optical member be prevented as much as possible.

Furthermore, when a reactive etching gas such as a chlorine gas is introduced into a dry etching space through a large number of micro pores (for example, pores having a diameter of 300 to 1500 μm) of a metal plate (for example, an electrode comprising an aluminum plate that has been subjected to an anodizing or an anodization or the like), in order to process a surface of a substrate (a glass substrate or the like), a reaction of the metal with the etching gas generates reaction products, and the products accumulate in the pores of the metal plate. The pores are consequently plugged. It is necessary to remove the products from the pores for reuse of the plate or to replace the plate with a new metal plate. Therefore, the necessity of the frequent maintenance work greatly decreases the productivity of the apparatus for processing the substrates.

Furthermore, in a dry etching (e.g., a plasma etching), a member contacting with (or exposed to) the processing space of the dry etching (e.g., a member constituting an inner wall and a member disposed in the processing space) is liable to be corroded by a plasma (a reactive plasma) generated from a high reactive (or corrosive) gas (etching gas). The corroded member needs a frequent maintenance and replacement, which leads to a decrease in the productivity of the dry etching apparatus. Therefore, the member contacting with the processing space needs a high plasma resistance.

In addition, when an accumulation of a matter adhered on an inside of a pipe or tube for transferring or transporting a fluid (e.g., a gas or vapor and a liquid) or a growth of a living matter or animate thing adhered thereon causes the pressure drop of the fluid, whereby a smooth transfer or transport of the fluid is prevented. In particular, in the case of a pipe or tube for transferring or transporting an acid matter, the pipe or tube is corroded from an inner surface, whereby the durability of the pipe or tube is decreased.

Japanese Patent Application Laid-Open No. 86960/1994 (JP-6-86960A, Patent Document 1) discloses a washing apparatus comprising a washing tank for accommodating an object to be washed, a cleaning liquid tank for containing a cleaning liquid, a water vapor (or a water steam) tank for containing a heated water vapor, and means for supplying a pressurized gas to pressurize the washing tank and the cleaning liquid tank. In the apparatus, the object to be washed is immersed in the cleaning liquid and cleaned in the cleaning tank. Then the cleaning liquid is removed from the washed object by spraying a heated water vapor. The document describes that a problem (washing for removing a micron-size dust or dirt adhered with an oil to part of a precision instrument) is solved, which has not been solved by spraying only a heated water vapor. Japanese Patent Application Laid-Open No. 79595/2004 (JP-2004-79595A, Patent Document 2) discloses a process for washing a substrate to remove a resist therefrom, which comprises subjecting a substrate having a resist on a surface thereof to a plasma ashing for less than 1 minute when the resist is not completely removed and spraying a cleaning gas comprising a water vapor to the surface of the substrate. The document also describes that a saturated water vapor and a heated water vapor may be used as the water vapor. Furthermore, Japanese Patent Application Laid-Open No. 346427/2004 (JP-2004-346427A, Patent Document 3) discloses a surface treatment that comprises disposing a metal workpiece in a processing space after making the processing space vacuous, and introducing a high-pressure heated water vapor into the processing space to form an oxide layer on the surface of the metal workpiece. The document also describes that forming the oxide layer of Fe₃O₄, not FeO or Fe₂O₃, on the surface of the metal workpiece improves the smoothness (lubricating property) and durability (wear-resistance and corrosion resistance) of the metal workpiece.

However, a method for preventing the adhesion of contaminants to a member over a long period of time and a method for providing a high acid resistance and plasma resistance to the member, have not been known.

### [Patent Document 1] JP-6-86960A (Claims)

[Patent Document 2] JP-2004-79595A (Claims and column of [Effects of The Invention])
[Patent Document 3] JP-2004-346427A (Claims and paragraph Nos. [0021] and [0046])

### DISCLOSURE OF THE INVENTION

### Problems to be Solved by the Invention

It is therefore an object of the present invention to provide a corrosion-resistant member which can maintain a high corrosion resistance (erosion resistance) over a long period of time, a process for producing the corrosion-resistant member a surface-treating process (or a surface-modifying process), and a surface-treated member (or a surface-modified member) obtainable by the surface-treating process (or the surface-modifying process).

Another object of the present invention is to provide a corrosion-resistant member which can maintain a high corrosion resistance and plasma-resistance over a long period of time, a process for producing the corrosion-resistant member, a surface-treating process (or a surface-modifying process), and a surface-treated member (or a surface-modified member) obtainable by the surface-treating process (or the surface-modifying process).

A further object of the invention is to provide a corrosion-resistant member having an improved (or enhanced) corrosion resistance (or acid resistance, plasma resistance) and hydrophilicity, a process for producing the corrosion-resistant member, a surface-treating process (or a surface-modifying process), and a surface-treated member (or a surface-modified member) obtainable by the surface-treating process (or the surface-modifying process).

### Means to Solve the Problems

The inventors of the present invention made intensive studies to achieve the above objects and finally found that spraying or ejecting a superheated water vapor to a member imparts a high corrosion resistance (or acid resistance or plasma resistance) and hydrophilicity to the member. The inventors found that such a surface-treating process realizes the long life of the member and the surface processing apparatus comprising the member, decreases the frequent maintenance work, and prevents the adhesion and accumulation of the particles on inside of the surface processing apparatus. In addition, the inventors found that the surface-treatment of the member results in an increase of the process yield of devices with a remarkable decrease of the production cost. Incidentally, the above-mentioned member may be a member contacting with (or exposed to) the processing space (e.g., a member constituting an inner wall and a member disposed in the processing space) in a semiconductor manufacturing apparatus or a liquid crystal device manufacturing apparatus. Such an apparatus includes, for example, a surface process apparatus utilizing a vapor phase method (e.g., a physical vapor deposition apparatus, a chemical vapor deposition apparatus, and an etching apparatus). The present invention was accomplished based on the above findings.

That is, the corrosion-resistant member (or surface-modified member, acid-resistant member, plasma-resistant member) of the present invention comprises an inorganic material and is characterized by a high corrosion resistance (or acid-resistance, plasma-resistance). For example, the index of wettability of the surface of the corrosion-resistant member measured in accordance with JIS K 6768 is about 35 to 45 (e.g., about 36 to 43). The index of wettability of the corrosion-resistant member is usually about 2 to 10 higher than that of an untreated member. Moreover, the corrosion-resistant member has a high acid resistance. For example, when a hydrochloric acid having a concentration of 35% is dropped on a surface of a corrosion-resistant member comprising an aluminum-magnesium-alloy (Al—Mg alloy), it takes not less than 45 minutes to generate a bubble on or from the member surface at a room temperature. For example, when a hydrochloric acid having a concentration of 35% is dropped on a surface of a corrosion-resistant member comprising an aluminum-magnesium-silicon alloy (Al—Mg—Si alloy), it takes not less than 75 minutes to generate a bubble on or from the member surface at a room temperature. In addition, such members have a small amount of metal elution when the members are exposed to a strong acid such as hydrofluoric acid. The corrosion-resistant member has a plasma resistance which is a resistance to a plasma generated from at least one gas selected from the group consisting of a rare gas, hydrogen, a nitrogen-containing gas, an oxygen-containing gas, a hydrocarbon, and a halogen-containing gas (particularly a gas containing a halogen).

The corrosion-resistant or surface-modified member may comprise at least one selected from the group consisting of a ceramic and a metal and may practically comprise an oxide ceramic, an oxidized metal or a metal, the oxide ceramic, the oxidized metal or the metal comprising at least one element selected from the group consisting of an element of the Group 3 of the Periodic Table of Elements, an element of the Group 4 of the Periodic Table of Elements, an element of the Group 5 of the Periodic Table of Elements, an element of the Group 13 of the Periodic Table of Elements, and an element of the Group 14 of the Periodic Table of Elements (for example, at least one element selected from yttrium, silicon, and aluminum). Typical examples of the surface-modified members include at least one comprising a member selected from an yttria, a silica or a glass, an alumina, an anodized aluminum or an alloy of an anodized aluminum, silicon, and aluminum or an alloy of aluminum (a stainless steel or the like), or the like.

The corrosion-resistant member may be, for example, a member that may be contactable with a processing space (e.g., an atmosphere or a processing space under a reduced pressure, and a processing space containing a floating or a flying particle) in a surface process apparatus utilizing a vapor phase method (an apparatus (a chamber or a reactor) for surface processing a base material by vapor phase). For example, the corrosion-resistant member may be a member constituting at least the inner surface of the surface process apparatus or disposed in the surface process apparatus. In other words, the corrosion-resistant member may be a member for a vacuum vessel such as a member for a vacuum chamber or reactor. The untreated member may also be a base material or a substrate treated or processed by a vapor phase method; or at least one selected from a transport jig, an electrode member, a holder, a boat, a covering member, an insulator, a constituting member for an inlet or an exhaust duct, an interior member, a plate, and a joining or a fixing member. Further, the corrosion-resistant member may be, for example, a member constituting an observation window for observing the inside of the vapor phase-surface process apparatus or a member having a pore through which an etching gas may pass. Examples of the vapor phase methods may include, for example, a physical vapor deposition, a chemical vapor deposition, an ion beam mixing method, an etching method, and an impurity doping method. Furthermore, the corrosion-resistant member may be a transparent protective member, an optical member, or a pipe for transferring a fluid in addition to a member that may be contactable with a processing space and a constituting member for an inlet or an exhaust duct.

The present invention also includes a corrosion-resistant member having an anodized aluminum layer thereon. The damaged (deteriorated) thickness of the anodized aluminum layer is about 3 to 25 μm when the corrosion-resistant member is subjected to an irradiation with a plasma generated from a mixed gas containing tetrafluoromethane, oxygen, and argon [tetrafluoromethane/oxygen/argon (volume ratio)=16/4/80] using a surface process apparatus utilizing a plasma (e.g., a plasma etching apparatus) for two hours.

In the process for producing the corrosion-resistant member of the present invention, an untreated member comprising at least one selected from the group consisting of a ceramic and a metal is treated with a superheated water vapor to give a corrosion-resistant member having acid resistance and plasma resistance. Moreover, the surface-treating process (or a surface-modifying process) of the present invention is a process for improving or enhancing the acid resistance and plasma resistance of the untreated member. In these processes, an untreated member comprising at least one selected from the group consisting of a ceramic and a metal is treated with a superheated water vapor. In these processes, the untreated member may be treated with a superheated water vapor having a temperature of 300 to 1000° C. (for example, about 350 to 1000° C.). The untreated member may be treated in a non-oxidizing atmosphere. In the processes, an amount (a spraying or ejecting amount) of the superheated water vapor, depending on the species of the untreated members, may be, for example, about 0.1 to 100 kg/h in terms of water vapor (or flow rate) relative to 1 m² of the surface area of the untreated member. In these processes, the untreated member may be treated with the superheated water vapor. The obtained member (surface-treated member or surface-modified member) prevents the adhesion of contaminants thereon. For example, the obtained member can prevent the adhesion of particles generated in the surface process using the vapor phase method. In addition to the above-mentioned advantages, these processes allow the untreated member to be inert to a reactive component, or an adhering or attaching component.

The present invention also includes a surface-treated member (such as the surface-modified member) treated by the surface-treating process.

### EFFECTS OF THE INVENTION

According to the present invention, the surface-treatment with the superheated water vapor allows the member to maintain a high corrosion resistance (or an acid resistance, a plasma resistance) for a long period of time. The surface-treatment can improve the hydrophilicity and corrosion resistance (or acid resistance, plasma resistance) of the member and prevent the adhesion of contaminants on the member. Therefore, the present invention decreases the frequency of maintenance work together with achieving the long life of the constituting member of the apparatus (the surface processing apparatus) and the apparatus itself, and the process yield of the devices can be improved. As a result, the production cost can be greatly reduced.

### DETAILED DESCRIPTION OF THE INVENTION

### Corrosion-Resistant Member

The corrosion-resistant member of the present invention comprises an inorganic material and has an improved surface wettability and corrosion resistance (or acid resistance, plasma resistance). The above-mentioned corrosion-resistant member (for example, a member constituting the surface process apparatus and the base material or the substrate to be treated by a microfabrication and/or a thin-film processing or lithography) has a surface or an area that may comprise at least an inorganic material or an inorganic substance.

The corrosion-resistant member may comprise various elements, for example, an element of the Group 2 of the Periodic Table of Elements (e.g., beryllium), an element of the Group 3 of the Periodic Table of Elements (e.g., scandium and yttrium), an element of the Group 4 of the Periodic Table of Elements (e.g., titanium and zirconium), an element of the Group 5 of the Periodic Table of Elements (e.g., vanadium, niobium, and tantalum), an element of the Group 6 of the Periodic Table of Elements (e.g., chromium, molybdenum, and tungsten), an element of the Group 7 of the Periodic Table of Elements (e.g., manganese), an element of the Group 9 of the Periodic Table of Elements (e.g., cobalt and rhodium), an element of the Group 10 of the Periodic Table of Elements (e.g., nickel, palladium, and platinum), an element of the Group 11 of the Periodic Table of Elements (e.g., copper, silver, and gold), an element of the Group 13 of the Periodic Table of Elements (e.g., boron, aluminum, gallium, and indium), and an element of the Group 14 of the Periodic Table of Elements (e.g., carbon, silicon, and germanium). The inorganic substance may contain an element of the Group 15 of the Periodic Table of Elements (e.g., nitrogen and phosphorus), an element of the Group 16 of the Periodic Table of Elements (e.g., oxygen), and an element of the Group 17 of the Periodic Table of Elements (a halogen such as fluorine). In practice, the corrosion-resistant member often comprises an element of the Group 3 of the Periodic Table of Elements (e.g., yttrium), an element of the Group 4 of the Periodic Table of Elements (e.g., titanium and zirconium), an element of the Group 5 of the Periodic Table of Elements, an element of the Group 13 of the Periodic Table of Elements (e.g., aluminum), and an element of the Group 14 of the Periodic Table of Elements (e.g., silicon and germanium) (particularly, at least one element selected from yttrium, silicon, and aluminum).

The corrosion-resistant member usually comprises at least one selected from the group consisting of a ceramic and a metal. The corrosion-resistant member includes a member comprising, for example, at least one selected from the group consisting of a ceramic [e.g., a metal oxide (a glass such as a low alkali glass or a quartz glass and an oxide ceramic such as a quartz or a silica, an alumina or an aluminum oxide, a silica-alumina, an yttria or yttrium oxide, sapphire, zirconia, titania or titanium oxide, mulite, or beryllia), a metal silicide (a ceramic silicide such as silicon carbide or silicon nitride), a metal nitride (a ceramic nitride such as boron nitride, carbon nitride, aluminum nitride, or titanium nitride), a boride (a ceramic boride such as carbon boride, titanium boride, or zirconium boride), a metal carbide (a ceramic carbide such as silicon carbide, titanium carbide, or tungsten carbide), and a porcelain enamel], a metal (a simple metal, e.g., a silicon such as a single crystal silicon, a polycrystalline silicon, or an amorphous silicon, titanium, aluminum, and germanium; an alloy such as an iron-base alloy (e.g., a stainless steel), a titanium alloy, a nickel alloy, an aluminum alloy (e.g., an aluminum-magnesium alloy (Al—Mg alloy), an aluminum-magnesium-silicon alloy (Al—Mg—Si alloy), and aluminum-zinc-magnesium alloy (Al—Zn—Mg alloy)), or a tungsten alloy), a carbonaceous material, and diamond.

Furthermore, the corrosion-resistant member may have been subjected to a surface treatment or a processing (for example, an oxidation treatment, a nitridation treatment, and a boridation treatment). For example, a metal member such as aluminum or an alloy thereof may have been subjected to a surface treatment (e.g., an anodization) or an oxidation treatment such as an anodizing (e.g., an anodizing with sulfuric acid, an anodizing with oxalic acid, an anodizing with chromic acid, and an anodizing with phosphoric acid). In practice, an anodized aluminum or an anodized aluminum alloy may be usually treated by a sealing. These members may be used singly or in combination. Moreover, the corrosion-resistant member may be a conductive member or a semicondactive member, or an insulating or a non-conductive member. Furthermore, the corrosion-resistant member may be a hydrophobic member or a hydrophilic member. In addition, the corrosion-resistant member may be an opaque, translucent, or transparent member.

The corrosion-resistant member often comprises an oxidized ceramic (e.g., an oxidized ceramic comprising an element selected from the group consisting of yttrium, silicon, and aluminum), an oxidized metal, or a metal. More specifically, in practice, the corrosion-resistant member may be contactable with a processing space of a layer-forming or a surface process apparatus (e.g., a chamber- or reactor-constituting member) using the vapor phase method. Such a member may include, for example, a ceramic (e.g., a silica or a glass such as a quartz glass and an oxide ceramic such as an alumina or an yttria), a metal (e.g., a metal such as silicon or aluminum and an alloy such as an aluminum alloy or a stainless steel), and an oxidized metal (e.g., an anodized aluminum or an anodized aluminum alloy).

The surface wettability and corrosion resistance of such a corrosion-resistant member are improved by the surface-modification compared with an untreated member, whereby the corrosion-resistant member has a high durability. When the surface wetting property of the corrosion-resistant member is measured in accordance with JIS K6768, the index of wettability is about 35 to 45, preferably about 36 to 43 (e.g., about 36 to 42), more preferably about 37 to 42 depending on the degree of surface process or surface modification. Moreover, owing to the surface-treatment, the index of wettability of the corrosion-resistant member is usually higher than that of an untreated member. The increase in the index of wettability due to the surface-treatment is about 2 to 10, preferably about 3 to 10, more preferably about 4 to 10 (e.g., 4 to 9), and particularly, about 5 to 8.

More specifically, the treatment with a superheated water vapor can increase the index of wettability of a quartz from the range of about 28 to 32 to the range of about 36 to 40. In addition, the treatment with a superheated water vapor can increase the index of wettability of a hard-anodized aluminium from the range of about 31 to 34 to the range of about 35 to 40. Incidentally, since the wettability depends on the degree of polishing of the surface or the unevenness of the surface, adjusting the degree of polishing of the surface can increase the index of wettability. However, in this case, only the improvement in wettability is achieved, but not the improvement in corrosion resistance. Even in the case of an untreated member whose index of wettability has been improved by adjusting the degree of polishing of the surface, the present invention improve or enhance further not only its inherent index of wettability but also corrosion resistance by subjecting the untreated member to a surface-treatment or surface-modification. For example, even a quartz which has been polished with a #320 grit sandpaper to adjust the wettability to about 38 is treated with a superheated water vapor to improve the inherent index of wettability to about 39 to 43 as well as the inherent corrosion resistance.

Incidentally, the index of wettability is indicated by the following manner: applying a standard solution for wetting on a surface of a sample at a room temperature (e.g., 15 to 25° C.); observing the wettability of the surface at two seconds after the application of the standard solution for wetting; regarding an index or number given to the standard solution for wetting which makes the sample surface completely wet as the index of wettability of the sample. Furthermore, the wettability is sometimes expressed in dyne unit.

Furthermore, the corrosion-resistant member having such a wetting property has a high hydrophilicity as well. In particular, the treatment with the superheated water vapor which is mentioned below remarkably reduces a contact angle of water on the treated member in comparison with the contact angle of water on the untreated member. When the contact angle of water for the corrosion-resistant member which has been treated with the superheated water vapor is measured under the condition of a temperature of about 15 to 25° C. (for example, about 20° C.) and a humidity of about 55 to 70% RH (for example, about 60% RH), the contact angle X₂ of the member treated with the superheated water vapor may, for example, be about 10 to 100°, preferably about 15 to 95°, and more preferably 20 to 90° (for example, about 30 to 85°), and about 40 to 97° depending on the species of the member to be treated. More specifically, an oxide ceramic or an oxide metal treated with the superheated water vapor may have a contact angle of water of, for example, about 30 to 100°, preferably about 35 to 95°, and more preferably about 40 to 95°. An alumina treated with the superheated water vapor may have a contact angle of water of about 30 to 60° (for example, about 35 to 55°, and more preferably about 40 to 50°); a quartz treated with the superheated water vapor may have a contact angle of water of about 80 to 105° (for example, about 85 to 100° and more preferably about 90 to 100°); and an aluminum which has been subjected to an anodizing and a sealing treatment may have an contact angle of water of about 30 to 80° (for example, about 35 to 70° and more preferably about 40 to 60°). Moreover, a metal (such as silicon) treated with the superheated water vapor may have a contact angle of water of about 10 to 25°, preferably about 10 to 23°, and more preferably about 10 to 20°.

Incidentally, the contact angle of water on a member without treatment by the superheated water vapor is as follows; an alumina may have a contact angle of water of about 70 to 80°; a quartz may have a contact angle of water of about 110 to 120°; an aluminum subjected to an anodizing and a sealing may have a contact angle of water of about 100 to 110°; and a silicon may have a contact angle of water of about 40 to 50°. In other words, the contact angle of water on the member treated with the superheated water vapor is lower than the contact angle of water on the untreated member. More specifically, assuming a contact angle of water on an untreated member is X₁ and a contact angle of water on the member treated with the superheated water vapor is X₂ under the condition of a temperature of 15 to 25° C. (for example, 20° C.) and a humidity of 55 to 70% RH (for example, 60% RH), Δ(X₁−X₂) may be about 15 to 70°, preferably about 18 to 65°, and more preferably about 20 to 60° (for example, about 25 to 55°). Further, such a high hydrophilicity is sustained over a long period of time. For example, the decrease rate of the contact angle of water is only about 5 to 40% (preferably about 10 to 35%) even after irradiating an ultra sonic on the treated member in an aqueous hydrogen peroxide for 3 hours. More specifically, when the quartz glass is treated by spraying or jetting the superheated water vapor having a temperature of 500° C. in an amount (or a flow rate) of 5 kg/h in terms of water vapor for 10 to 20 minutes, the contact angle of water may be, for example, about 85 to 100° under the condition of a temperature of 20° C. and a relative humidity of 60% RH. Even though the treated quartz glass is irradiated with an ultra sonic in an aqueous hydrogen peroxide for 3 hours, the contact angle of water is about 60 to 70°. Contrarily, when the quartz glass is irradiated with an ultra sonic in an aqueous hydrogen peroxide for 3 hours before the treatment with superheated water vapor, the contact angle of water thereof is reduced to about 10 to 20°.

That is, the contact angle of water for the corrosion-resistant member of the present invention may be 10 to 100° and may be 15 to 70° lower than that of an untreated member.

As mentioned above, the corrosion-resistant member of the present invention has an excellent acid resistance and a high corrosion resistance. The corrosion-resistant member shows a high acid resistance to not only a weak acid (such as acetic acid) but also to a strong acid (e.g., hydrochloric acid, dilute sulfuric acid, a mixed acid, and hydrofluoric acid). For example, even in an elution test using 15% hydrofluoric acid at a room temperature for about 16 minutes, a surface-treated or surface-modified quartz has a reduced elution amount. Accordingly, owing to the surface-treatment or surface-modification, the corrosion-resistant member has a small elution amount even in a case of being exposed to a strong acid (e.g., hydrofluoric acid).

Specifically, in the case of a corrosion-resistant member comprising an aluminum-magnesium alloy (e.g., A5052), when hydrochloric acid having a concentration of 35% (35% concentration hydrochloric acid) is dropped on a surface (e.g., anodized surface) of the member which has not been subjected to a surface-treatment or surface-modification with a superheated water vapor, it takes about 30 to 40 minutes (e.g., about 32 to 38 minutes) to generate a bubble on or from the surface of the member at a room temperature. On the other hand, when hydrochloric acid having a concentration of 35% (35% concentration hydrochloric acid) is dropped on a surface (e.g., anodized surface) of the member which has been subjected to a surface-treatment or surface-modification with a superheated water vapor, it takes not less than 45 minutes (e.g., about 50 to 150 minutes, and particularly about 60 to 120 minutes) to generate a bubble on or from the surface of the member a at a room temperature. In the case of a member comprising an aluminum-magnesium-silicon alloy (e.g., A6061), when hydrochloric acid having a concentration of 35% (35% concentration hydrochloric acid) is dropped on a surface (e.g., anodized surface) of the member which has not been subjected to a surface-treatment or surface-modification with a superheated water vapor, it takes about 40 to 75 minutes (e.g., 50 to 75 minutes) to generate a bubble on or from the surface of the member at a room temperature. On the other hand, when hydrochloric acid having a concentration of 35% (35% concentration hydrochloric acid) is dropped on a surface (e.g., anodized surface) of the member which has been subjected to a surface-treatment or surface-modification with a superheated water vapor, it takes not less than 80 minutes (e.g., about 85 to 150 minutes, and particularly about 90 to 120 minutes) to generate a bubble on the surface of the member at a room temperature.

Incidentally, in order to improve (or enhance) adhering property or adhesiveness, the wettability of the member is often increased. Accordingly, a member having a high wettability is expected to have a high adhesiveness to or affinity for contaminants greatly. Although the corrosion-resistant member of the present invention has a high wettability, the corrosion-resistant member has a unique property, that is, an inertness to an active component (e.g., a reactive component such as a reactive gas and an adhesive component). Therefore, the corrosion-resistant member of the present invention can prevent the adhesion of contaminants owing to the surface-modification. Even if the contaminants adhere on a surface of the corrosion-resistant member, the surface thereof is easily cleaned by only wiping the surface. Moreover, as mentioned above, since the corrosion-resistant member is inert or inactive and has acid resistance, even if the member contacts with an acidic material, the member does not corroded. Therefore, the corrosion-resistant member can maintain a high corrosion resistance and durability over the long period of time.

Furthermore, the corrosion-resistant of the present invention has a high etching resistance or plasma resistance (e.g., plasma-etching resistance). An etching process (particularly, a dry etching process, e.g., plasma etching process) usually utilizes various gases mentioned below or a plasma generated therefrom. In a processing space for such an etching, a member contactable with the processing space (such as a member constituting an inner wall or a member disposed in the processing space) is liable to be eroded (or corroded). Therefore, imparting etching resistance or plasma resistance (e.g., plasma-etching resistance) to the member contactable with a processing space of a surface process apparatus is critically important for increasing the productivity of the surface process apparatus. Owing to a surface-modification (a superheated water vapor treatment), the corrosion-resistant member of the present invention has a high resistance (or a high plasma resistance) to various gases (e.g., a rare gas, hydrogen, a gas containing nitrogen, a gas containing oxygen, and a hydrocarbon) or to a plasma generated therefrom. In particular, the corrosion-resistant member has a high resistance (or a high plasma resistance) to a gas having a high reactivity (or corrosive property) [e.g., a reactive gas containing a halogen (such as chlorine or fluorine)] or to a plasma generated therefrom.

Specifically, when a corrosion-resistant member (e.g., an aluminum plate having an anodized aluminum layer formed by a hard anodizing treatment) is subjected to an irradiation with a plasma generated from a mixed gas containing tetrafluoromethane, oxygen, and argon [(tetrafluoromethane/oxygen/argon (volume ratio)=16/4/80)] at a degree of vacuum of 4 Pa (30 mTorr) for two hours using a plasma-surface-treatment apparatus (for example, an etching apparatus using a plasma-etching), the damaged (deteriorated) thickness (or reduced thickness) of the anodized aluminum layer may be about 3 to 25 μm (e.g., about 5 to 24 μm), preferably about 7 to 23 μm (e.g., about 10 to 22 μm), and more preferably about 10 to 21 μm (e.g., about 15 to 21 μm).

Incidentally, when a member (e.g., an aluminum plate having an anodized aluminum layer formed by a hard anodizing treatment) which has not been treated with a superheated water vapor is subjected to an irradiation with the plasma for two hours under the same condition as mentioned above, the damaged thickness (or reduced thickness) of the anodized aluminum layer is about 26 to 40 μm (e.g., about 26.5 to 38 μm). That is, in comparison with the untreated member, the corrosion-resistant member (the member treated with a superheated water vapor) has a decrease in the damaged thickness (reduced thickness) of the anodized aluminum layer due to the plasma irradiation and an enhanced resistance to plasma (plasma resistance). More specifically, let the damaged thickness (reduced thickness) of the anodized aluminum layer of the untreated member be Y₁ and that of the corrosion-resistant member (the member treated with a superheated water vapor) be Y₂. When being subjected to the irradiation with a plasma generated from a mixed gas containing tetrafluoromethane, oxygen, and argon (tetrafluoromethane/oxygen/argon (volume ratio)=16/4/80) at a degree of vacuum of 4 Pa (30 mTorr) for two hours, the difference between Y₁ and Y₂ [Δ(Y₁−Y₂)] may be about 2 to 15 μm, preferably, about 3 to 14 μm, and more preferably about 4 to 12 μm (e.g., about 5 to 10 μm). The improvement in the plasma resistance due to the surface treatment with a superheated water vapor [(Y₁−Y₂)/Y₁×100(%)] may be, for example, about 10 to 40%, preferably, about 12 to 35%, more preferably about 15 to 33%, particularly about 17 to 30% (e.g., about 20 to 30%).

[Use of Corrosion-Resistant Member]

Accordingly, the corrosion-resistant of the present invention may be used as various members requiring the prevention of the adhesion of contaminants or the stains (for example, liquid components such as oils, liquid seasonings (e.g., a soya sauce), and coffee, particulate components such as dust or dirt and flying particles, solid components such as crayons and paints). The member to be treated (i.e., the untreated member) is not particularly limited to a specific one. The member to be treated (i.e., the untreated member) that may be exposed to a liquid contaminant may include, for example, a tableware or a container such as a cup, a plate, and a glass, a pan or a fraying pan such as a cooking pan, furniture such as a table or a chair, a pipe, a coating apparatus or a member thereof, a storage tank or a storage vessel (or bath), and an apparatus for treatment with (or utilizing) a liquid phase. The member to be treated that may be exposed to a particulate contaminant or a solid contaminant may include, for example, a chute or a hopper constituting a carrying path, a storage vessel, and an inner member of an apparatus for treatment in a vapor phase. Furthermore, the present invention may be applied to a member which may be contaminated with various contaminants, for example, an exterior or an interior member (e.g., a member for a building such as a window glass and a tile or a porcelain enamel-based building material and a cooking table; a member constituting a vehicle such as an automobile, e.g., an automobile body, a windshield, a window glass, a mirror, a protective cover for a lamp, and a piston member), a fence (e.g., a highway fence such as a sound proof fence for an express way), and a protective cover member (e.g., a protective cover for a light source such as a lighting unit or a halogen lamp in a tunnel or in a house; a protective cover member for a precision machine such as a watch, a clock, or a camera; a display protective cover member such as a front panel for a picture or an image display device, e.g., a television, a personal computer, or a mobile phone; a protective cover member for a solar battery; and a protective cover for a signal lamp). Furthermore, the present invention may also be effectively applied, for example, to a member for inside of a clean room (e.g., a member for an inner wall, a flooring member, a casing member of an apparatus in a clean room, and an exterior member therefor), a metal mold (e.g., a metal mold for an injection molding), an optical member (such as a lens including a pickup lens, a prism, a light reflector, a mirror, or a photomask), a member constituting an image-forming apparatus (or device) or an acoustic device (e.g., a head such as a printer head or a magnetic head, and a transfer roll for transferring a toner to a substrate sheet), a member for an electronic machine or an electronic telecommunications apparatus (e.g., a recording medium such as a CD or a DVD, and a member for recording or reading data).

According to the present invention, the adhesion of the contaminants can be prevented over a long period of time. Moreover, even though the contaminants attach to the member, the contaminants are easily cleaned up with a simple cleaning manner (cleaning, e.g., wiping out and other operation or manner). Accordingly, cleaning an apparatus for a production of a microfabricated substrate (such as a semiconductor or a liquid crystal substrate) requires a small amount of an acid (e.g., a strong acid such as hydrochloric acid, dilute sulfuric acid, hydrofluoric acid, or a mixed acid), a cleaning liquid (e.g., SC-2 cleaning liquid containing hydrochloric acid and hydrogen peroxide, SPM cleaning liquid containing sulfuric acid and hydrogen peroxide, FPM cleaning liquid containing hydrofluoric acid and hydrogen peroxide, BHF cleaning liquid containing hydrofluoric acid (buffered hydrofluoric acid solution), and a hydrocarbon-series cleaning liquid), a pure water, or the like. Additionally, it is possible to reduce the amount of a pure water used for cleaning off the used cleaning liquid or pure water. Therefore, the corrosion-resistant member of the present invention is preferably used as a member on which the contaminants deposit or adhere in a liquid phase or in a vapor phase. Such a member may be a member used in or subjected to a liquid phase (or a member of a surface coating or processing apparatus for surface treating a base material or a substrate by application of liquid phase thereto or by the virtue of liquid phase), for example, a glass for a water tank, a glass used for an aquarium, and a transparent member (such as a glass) for a viewing window in a plant.

Moreover, the use of the corrosion-resistant member for a surface process apparatus can improve the etching resistance or plasma resistance in comparison with the use of an untreated member. Therefore, the corrosion-resistant member may preferably be used for a member constituting an apparatus for microfabricating or thin-film processing a semiconductor, a liquid crystal substrate, or the like. Such a member may include a member contactable with a processing space (e.g., an atmosphere or a processing space under a reduced pressure, and a processing space containing a floating or a flying particle) in a surface process apparatus by a vapor phase method (an apparatus (a chamber or a reactor) for surface processing a base material by vapor phase). For example, a member constituting at least the inner surface of the surface process apparatus or disposed in the surface process apparatus. In other words, the corrosion-resistant member may be used as a member for vacuum vessel (e.g., a vacuum chamber and a vacuum reactor). In addition, the corrosion-resistant member may be used as a constituting member for an inlet or exhaust duct (or a flow channel) of the surface process apparatus [e.g., a member constituting an inner surface of a vacuum pump (such as a screw or a trap]. The improvement in the corrosion resistance of such a member (particularly, a member constituting an inner surface of a vacuum pump) and the prevention of the adhesion of contaminants, not only can reduce the frequency of the maintenance work (or replacement) of the member, but also can avoid a decrease in the performance in the surface process apparatus.

The surface process by the vapor phase method may include a physical vapor deposition (PVD), a chemical vapor deposition (CVD), an ion beam mixing, an etching, an impurity doping, or the like. Incidentally, the surface process using the vapor phase method may utilize a gaseous component (such as oxygen, nitrogen, or argon gas) in addition to a component such as a ceramic, a metal, a metal compound, an organo-metallic compound, or an organic substance (e.g., a fluorocarbon resin and a polyimide resin), depending on the species of thin-layer processing or lithographic techniques (or thin-film processing methods), and the like. For example, a component forming the following layer may be used: a layer for an electrode or a layer for a wire (or an interconnection), a resistance layer, a dielectric layer, an insulating layer, a magnetic layer, a conductive layer, a superconductive layer, a semiconductive layer, a protective layer, an abrasion-resistant layer, a very hard (or high hard) layer, a corrosion resistance layer, a heat-resistant layer, and a decoration layer.

The physical vapor deposition may include a deposition (or a vacuum deposition), for example, a deposition using a heating means such as a resistance heating, a flash evaporation, an arc evaporation, a laser heating, a high-frequency heating, or an electron beam heating; an ion plating technique utilizing a ionization process such as a high-frequency wave, a direct current, or a hollow cathode discharge (HCD) (for example, a hollow cathode discharge (HCD) process, an electron process, a beam RF process, and an arc discharge process); a sputtering (e.g., a sputtering utilizing a direct current discharge, an RF discharge or the like (for example, a glow discharge sputtering, an ion beam sputtering, and a magnetron sputtering)); a molecular beam epitaxy process, and the other process. The sputtering may be conducted with a reactive gas, for example, an oxygen source (e.g., oxygen), a nitrogen source (e.g., nitrogen and ammonia), a carbon source (e.g., methane and ethylene), and a sulfur source (e.g., hydrogen sulfide). These reactive gases may be used in combination with a sputtering gas, e.g., a noble gas such as argon and hydrogen.

The chemical vapor deposition may include a thermal CVD process, a plasma CVD process, an MOCVD process (an organo-metallic chemical vapor deposition), a photo-induced-CVD process (a CVD process utilizing rays such as ultraviolet rays and laser beams), and a CVD process utilizing a chemical reaction, and others.

The etching may include a dry etching, for example, a vapor phase etching such as a plasma etching, a reactive ion etching, or a micro wave etching. The etching gas in the dry etching may be optionally selected depending on the kind of base materials or substrates. The etching gas may include an inactive (or low reactive) gas such as a rare gas (e.g., helium, neon, and argon), hydrogen, a nitrogen-containing gas (e.g., nitrogen and ammonia), an oxygen-containing gas (e.g., oxygen, carbon monoxide, and carbon dioxide), a hydrocarbon (e.g., methane and ethane). Moreover, the etching gas may include a high reactive (or corrosive) gas such as a halogen-containing gas (e.g., a fluorine-containing gas and a chlorine-containing gas). The typical examples of the halogen-containing gas include, for example, an acidic gas (or acidic component) (e.g., hydrogen fluoride, hydrogen chloride, and chlorine); a halogenated hydrocarbon (e.g., tetrafluoromethane, hexafluoroethane, trifluoromethane, carbon tetrachloride, dichlorodifluoromethane, and trichlorofluoromethane; and a non-acidic gas (non-acidic component) (e.g., BF₃, NF₃, SiF₄, SF₆, BCl₃, PCl₃, and SiCl₄). These etching gases may be used alone or in combination. The etching gas may be supplied into the processing space, and the gas may also be supplied into the space between the electrodes in the same manner as in the reactive etching. The impurity doping may include a vapor phase heat diffusion process, an ion implantation process (an ionic implantation), a plasma doping process, or the like. The source of impurities (or a dopant) may be an arsenic compound (e.g., AsH₃), a boron compound (e.g., B₂H₆ and BCl₃), a phosphorus compound (e.g., PH₃), or the others. Besides the above-mentioned processes, the surface process by the vapor phase method includes a surface melting treatment with a laser or with a charged beam.

The surface process (or the surface fabrication) utilizing such a vapor phase method for a base material or a substrate may include a surface process in a semiconductor manufacturing apparatus, a liquid crystal display device, and an optical apparatus or a part thereof (e.g., a CCD and a shadow mask) and a sensor (e.g., a temperature sensor and a distortion sensor). Such a process may include a microfabrication and/or a thin-film processing or lithographic process, e.g., a microfabrication and/or a thin-film processing or lithographic process of a semiconductor substrate, a liquid crystal substrate, or the like; a functional layer forming process or treatment (a formation of a magnetic layer of a magnetic tape, a magnetic head or the like, an optical layer formation, a conductive layer formation, an insulating layer formation, a formation of a layer for a magnetometric sensor, or the like); and a coating treatment (for example, a coating or covering of an automobile part, an industrial tool or a precision machinery component (or a part), an optical component, a general merchandise, or the like, e.g., a formation of a functional layer such as a reflective layer, a heat-resistant layer, a corrosion-resistant layer, an abrasion-resistant layer, or a decoration layer). The preferable surface process includes a microfabrication and/or a thin-film processing or lithography.

For the base material or the substrate that is treated by the above-mentioned vapor phase method, various materials may be used depending on the species of the surface treatments, and may include, for example, a metal (e.g., aluminum, silicon, germanium, and gallium), diamond, a ceramic [for example, a metal oxide (e.g., an yttria, a glass, a quartz or a silica, an alumina, and sapphire), a metal silicide (e.g., silicon carbide, silicon nitride, and silicide), a metal nitride (e.g., boron nitride and aluminum nitride), and a boride (e.g., titan boride)], a plastic or a resin (e.g., a film or a molded article in the form of a sheet, and a molded article such as a casing or a housing).

Such a surface process by vapor phase method (vapor phase surface process) utilizes the adhesion of scattering or flying particles (e.g., the particles for deposition and the sputtered particles) to the base material or to the substrate, regardless whether the particles are accelerated or ionized or not. Therefore, the scattering or flying particles adhere or deposit to an inner surface (or an inner wall) of the apparatus and accumulate thereon to contaminate the inner surface (or an inner wall) of the vapor phase surface process apparatus. In these cases, the surface process apparatus itself and the constituting member thereof require the frequent maintenance for cleaning, and the continuous operation of the apparatus causes a growth of the adhered components to form particles and contaminates the surface processed base material or substrate. As a result, the production cost increases with decreasing the process yield of the surface processed base materials or substrates.

On the other hand, using the corrosion-resistant member (the member subjected to the treatment with the superheated water vapor) as a constituting member of apparatus for a microfabrication or a thin-film processing or lithography process of a semiconductor substrate, a liquid crystal substrate, or the like, can effectively prevent the adhesion of the various contaminants or corrosion due to the various contaminants including the scattering or flying particle, particularly, the adhesion of the particle generated in the surface processing step using the vapor phase method or the corrosion due to the particle mentioned above. The apparatus mentioned above may include, e.g., a constituting member of a chamber or reactor of the surface process apparatus (particularly a member contacting with (or exposed to) the processing space in the surface process apparatus such as, at least, a member constituting an inner wall or a member disposed in the processing space). The constituting member mentioned above may include various members disposed in the surface process apparatus (i.e., a member for a vacuum vessel such as a vacuum chamber or reactor, or the like). Examples of the member to be disposed in the surface process apparatus include a base material or a substrate (e.g., a wafer) to be treated by the vapor phase method (for example, the microfabrication and/or the thin-film processing or lithography process), a transport jig (e.g., a wafer carrier), an electrode member (e.g., the above-mentioned electrode member being contactable with (or exposed to) an etching gas or a generated particle (or a plasma) in an etching apparatus), a holder or a supporter (e.g., a holder for a base material or a substrate to be treated, a holder for an electrode, a target holder, a susceptor, and a prop (or brace member)), a boat, a covering member (e.g., an inner shielding cover, a fixed block cover, a screw cap, a block cap for a prop, and a shielding member or a cap member), an insulator, a member constituting an inlet or exhaust duct (or breather) (e.g., a member constituting an inlet or exhaust duct or a channel such as a baffle member or a diffuser), and an interior member [for example, an inner wall or interior member (e.g., an inner wall member such as an inner wall board, a corner member, an inner wall gate member, a tube member for an inner wall, a member for an observation window (for example, a sensor window for a process detection unit in the vapor phase method (e.g., an end point detection unit) and a frame such as a corner frame)], a plate (e.g., a face plate, a pumping plate, a blocker plate, and a cooling plate), and a fixing member (e.g., a connecting or fixing member such as a fixing block, a screw (such as a bolt or a screw nut), a coupling, a flange, a joint, a ring (e.g., a clamp ring, a set ring, an earth ring, and an inner ring), or a tube). In addition, the corrosion-resistant member is useful as, e.g., a transparent protective member (such as a windshield for vehicle, a window glass (pane), or a protective covering member for a solar cell), an optical member (such as a lens, a prism, or a photomask), and a pipe or tube for transporting a fluid (in the surface-treatment apparatus, a pipe through which a reactive gas such as a processing gas passes, a canal member (such as a pipe line or a plumbing) constituting a vacuum pump.

In practice, the preferred corrosion-resistant member may usually comprise an inorganic substance (e.g., a ceramic and a metal), and includes, for example, a window member (e.g., a transparent member such as a glass or a quartz glass) for observing the inside of the vapor phase surface process apparatus (a chamber) and a member exposed to or contacted with the etching gas or the generated particle (or a plasma) (for example, a member having pores through which an etching gas such as a chlorine gas may pass, such as an upper electrode and/or a lower electrode for the dry etching apparatus) and the like. The corrosion-resistant member is useful as a constituting member of an apparatus containing a reactive material, for example, a constituting member of a surface process apparatus utilizing a halogen-containing gas. In particular, the corrosion-resistant member is useful as a constituting member of an apparatus for a dry etching (e.g., a plasma etching) utilizing the above-mentioned acidic gas.

The corrosion-resistant member of the present invention may be used as a constituting member of a surface process apparatus which contacts with the above-mentioned reactive gas (e.g., a halogen-containing gas). For example, in the case of an aluminum plate which has been anodized to form an anodized aluminum layer and then surface-modified, in a plasma etching apparatus equipped with an upper electrode comprising such an aluminum plate, when a glass substrate (e.g., a glass substrate having 116 mm in length by 116 mm in width by 8 mm in thickness) is subjected to an etching, the reduced thickness (damaged thickness) of the anodized aluminum layer of the aluminum plate is only about 1×10⁻⁶ to 5×10⁻⁴ μm, preferably only about 7×10⁻⁵ to 3×10⁻⁴ μm, and more preferably only about 5×10⁻⁵ to 2×10⁻⁴ μm, per a piece of the glass substrate subjected to the etching. Incidentally, in the case of an aluminum plate which has been only anodized to form an anodized aluminum layer, in a plasma etching apparatus equipped with an upper electrode comprising such an aluminum plate, when a glass substrate (e.g., a glass substrate having 116 mm in length by 116 mm in width by 8 mm in thickness) is subjected to an etching, the reduced thickness (damaged thickness) of the anodized aluminum layer of the aluminum plate may be about 1×10⁻⁴ to 5×10⁻³ μm per a piece of the etched glass substrate. The proportion of the reduced thickness (damaged thickness) of the anodized aluminum layer of the surface-modified member relative to that of the untreated member [the former/the latter] may be about ⅕ to 1/20, preferably, about ⅙ to 1/18, and more preferably, about 1/7 to 1/15, per a piece of the etched glass substrate. That is, the corrosion-resistant member (the member subjected to a surface-modification) has a lower reduced thickness (damaged thickness) of the anodized aluminum layer and an increased resistance to a plasma (plasma resistance) in comparison with an untreated member.

[Process for Producing Corrosion-Resistant Member and Process for Surface-Treating Member]

The corrosion-resistant member having acid resistance and plasma resistance of the present invention can be produced by treating a member comprising an inorganic substance (e.g., a member comprising at least one selected from the group consisting of a ceramic and a metal) with a superheated water vapor. That is, the present invention includes a process for improving (or enhancing) the acid resistance and plasma resistance of the member, which comprises a step of surface-treating a member comprising at least one selected from the group consisting of a ceramic and a metal with a superheated water vapor.

As the superheated water vapor, there may be used a superheated water vapor (a saturated water vapor) usually having a temperature higher than about 200° C., and preferably not lower than 250° C. (for example, about 250 to 1200° C.) particularly, a superheated water vapor (a saturated water vapor) indicating a temperature not lower than about 300° C. (for example, about 300 to 1200° C.) on a surface of the member being treated. The temperature of the superheated water vapor may be not lower than about 300° C. (for example, about 300 to 1000° C.), preferably about 330 to 1000° C. (for example, about 350 to 1000° C.), more preferably about 370 to 900° C. (for example, about 380 to 800° C.), and particularly about 400 to 750° C. (for example, about 450 to 700° C.) on a surface of the member being treated. The superheated water vapor may be generated by a conventional manner, for example, using a superheated water vapor-generating apparatus (such as a heater or a boiler) comprising a water vapor-generating unit to generate a saturated water vapor from a purified water or a pure water or a tap water and a superheating unit for superheating the water vapor from the water vapor-generating unit to a predetermined temperature by a superheating means (such as a high-frequency induction heating). In order to subject the untreated member to the surface-treatment, the superheated water vapor from the superheating unit of the superheated water vapor-generating apparatus is sprayed or ejected to the member to be treated to allow the superheated water vapor to contact with the member to be treated. The member to be treated may be treated, being accommodated or held in the processing unit. The member to be treated may also be treated while being transported. Incidentally, in the surface-treatment, a predetermined site (or area) of the member may be selectively treated by using a mask or the like.

Depending on the species of the corrosion-resistant members or the like, the amount to be used of the superheated water vapor for the treatment may be selected from a range of about 0.05 to 200 kg/h (for example, about 0.15 to 150 kg/h) in terms of water vapor (or flow rate) relative to 1 m² of the surface area of the untreated member. The amount (or the flow rate) of the superheated water vapor in terms of water vapor relative to 1 m² of the surface area of the untreated member may be, for example, about 0.1 to 100 kg/h, preferably about 0.25 to 80 kg/h, more preferably about 0.5 to 60 kg/h (for example, about 1 to 50 kg/h), and may be about 5 to 45 kg/h (for example, about 10 to 40 kg/h), and usually about 10 to 100 kg/h.

The treatment time with the super heated water vapor may be selected from a range of, for example, about 10 seconds to 6 hours depending on the species of the member to be treated, and may usually be about 1 minute to 2.5 hours (for example, about 2 to 120 minutes), preferably about minutes to 2 hours (for example, about 10 to 90 minutes), and more preferably about 10 minutes to 1.5 hours (for example, about 15 to 60 minutes). The treatment time may be about 20 seconds to 50 minutes, preferably about 30 seconds to 45 minutes (for example, about 45 seconds to 40 minutes), and more preferably about 1 to 40 minutes (for example, about 5 to 30 minutes).

The treatment of the member to be treated may be conducted under an oxygen or an oxygen-containing atmosphere (e.g., in air), as well as under a non-oxidizing atmosphere (or an inactive gas) such as nitrogen gas, helium gas, or argon gas.

The treatment mentioned above imparts corrosion resistance (acid resistance and plasma resistance) and hydrophilicity to the member to be treated. Furthermore, with imparting hydrophilicity to the member to be treated, the antistatic properties (electrostatic eliminating properties) of the corrosion-resistant member can be improved. Incidentally, in the test previously conducted, the surface potential of the corrosion-resistant member (for example, an insulating member such as a quartz glass) treated with the superheated water vapor may be measured, for example, by scanning the treated plate at a predetermined speed (90 cm/min) in accordance with the method defined by JIS (Japanese Industrial Standards) L1094 at a temperature of 20° C. and a humidity of 40% RH. The surface potential of the treated member that is measured by the above manner may be about 0 to ±75 V, preferably about 0 to ±70 V, more preferably about 0 to ±60 V, and particularly about 0 to ±50 V at a scanning time of 0 to 120 seconds. More specifically, the surface potential of the member treated with the superheated water vapor may be about 0 to ±30 V (for example, about 0 to ±25 V, preferably about 0 to ±20 V) at a scanning time of 0 second, about 0 to ±50 V (for example, about 0 to ±40 V, preferably about 0 to ±30 V) at a scanning time of 30 seconds, 0 to ±70 V (for example, about 0 to ±60 V, preferably about 0 to ±50 V) at a scanning time of 60 seconds, about 0 to ±75 V (for example, about 0 to ±70 V, preferably about 0 to ±60 V) at a scanning time of 90 seconds, and about 0 to ±75 V (for example, about 0 to ±70 V, preferably about 0 to ±60 V) at a scanning time of 120 seconds.

When the corrosion member treated with the super heated water vapor (the modified member) is approached cigarette ashes stored in a container (e.g., a Petri-dish) at a distance of 1 cm under the condition of a temperature of 20° C. and a humidity of 40% RH, the member does not have the adhesion of the cigarette ash and has a remarkably high non-electrostatic property or electrostatic eliminating property. In this ash test, the member may be subjected to the test after rubbing the member (the sample) with a dry cloth (a cotton cloth) for 10 seconds or without rubbing. Even in the both cases, the member has the high non-electrostatic property or the high electrostatic eliminating property.

Accordingly, the corrosion-resistant member of the present invention may be a member which comprises at least one selected from the group consisting of a ceramic and a metal, can prevent the adhesion of the contaminants thereon owing to the surface-modification, and is free from cigarette ashes in the ash test. Moreover, an X-ray photo electron spectrum (XPS) analysis of the member shows a decrease in the carbon atomic concentration and an increase in the oxygen atomic concentration of the surface thereof compared with an untreated member.

Furthermore, for example, when the member to be treated (e.g., an insulating member such as a quartz glass) is sprayed or ejected with the superheated water vapor having a temperature of 500° C. and an amount of 5 kg/h in terms of water vapor (or flow rate) for about 10 to 20 minutes and the obtained corrosion-resistant member (surface-modified member) is deposed in the surface process apparatus using the vapor phase method, even after substrates and the like are subjected to the microfabrication or the thin-film processing or lithography in the surface process apparatus, the treated member can suppress the increase of surface potential. More specifically, the surface potential of the member (for example, the quartz glass) treated with the superheated water vapor can be measured by the following manner: after a plurality of the substrates are repeatedly subjected to a microfabrication or a thin-film processing in a surface processing apparatus (or a vacuum chamber) such as a dry etching apparatus or a plasma etching apparatus or the like, and the member is detached from the surface process apparatus to measure the surface potential at a temperature of about 15 to 25° C. (for example, about 20° C.) and a humidity of about 55 to 70% RH (for example, about 60% RH). According to the above-mentioned method, the surface potential of the electrically insulting member (e.g., the quartz glass) may be, for example, about −3 to +2 kV (for example, about −2.7 to +1.5 kV, preferably about −2.5 to +1 kV, and more preferably −2.3 to +0.7 kV). Incidentally, depending on the species of the electrical insulating member, the surface potential of the electrical insulating member treated with the superheated water vapor may be positive (plus) or negative (minus).

Moreover, the treatment with the superheated water vapor seems to inactivate the member and to decrease the reactivity with a reactive component (a reactive gas or the like) and the affinity of the member for the contaminants. The adhesion of contaminants to or on the corrosion-resistant member or the corrosion due to contaminants of the corrosion-resistant member is effectively prevented. Further, an X-ray photo electron spectrum (XPS) analysis shows a decrease in the carbon atomic concentration and an increase in the oxygen atomic concentration of the surface of the member surface-treated with the superheated water vapor.

When the depth profile of the surface of the member treated with the superheated water vapor (or the surface-modified member) is analyzed by an X-ray photo electron spectrum, the member has a decreased carbon atomic concentration (atomic %) and an increased oxygen atomic concentration (atomic %) in comparison with the surface of an untreated member. When the depth profile of the surface of the member treated with the superheated water vapor (or the surface-modified member) is analyzed by an X-ray photo electron spectrum (“ESCA3300” manufactured by SHIMADZU CORPORATION), the relationship between the carbon atomic concentration and an etching time (at an etching speed of 5 nm/min) is as follows: about 10 to 50% (for example, about 15 to 45%) at an etching time of 0 second, about 5 to 35% (for example, about 7 to 30%) at an etching time of 15 seconds, about 5 to 30% (for example, about 7 to 25%) at an etching time of 30 seconds, and about 3 to 25% (for example, about 5 to 20%) at an etching time of 60 seconds; and the relationship between the oxygen atomic concentration and an etching time (at an etching speed of 5 nm/min) is as follows: about 30 to 60% (for example, about 33 to 55%) at an etching time of 0 second, about 35 to 62% (for example, about 40 to 60%) at an etching time of 15 seconds, about 43 to 63% (for example, about 45 to 60%) at an etching time 30 seconds, and about 45 to 65% (for example, about 50 to 60%) at an etching time of 60 seconds.

That is, when the depth profile of the surface of the corrosion-resistant member of the present invention is analyzed by the X-ray photo electron spectrum at an etching speed of 5 nm/min, the member has any one of the following carbon atomic concentrations: 10 to 50% at an etching time of 0 second; 7 to 35% at an etching time of 15 seconds; 5 to 30% at an etching time of 30 seconds; and 3 to 25% at an etching time of 60 seconds; and any one of the following oxygen atomic concentrations: 30 to 60% at an etching time of 0 second; 35 to 62% at an etching time of 15 seconds; 43 to 63% at an etching time of 30, seconds; and 45 to 65% at an etching time of 60 seconds, on the surface of the treated member (e.g., a ceramic and an alumite).

More specifically, in the oxide ceramic, the oxide metal, and the metal, the relationships between the carbon atomic concentration and the oxygen atomic concentration, and the etching time are as follows;

(A) Member Comprising a Ceramic (e.g., An Oxide Ceramic) or an Alumite:

(1) Carbon Atomic Concentration (Atomic %)

The carbon atomic concentrations (atomic %) of the member comprising a ceramic (e.g., an oxide ceramic) or an alumite are as follows.

TABLE 1

| | Etching time | | | |
|---|---|---|---|---|
| | | | 30 | 60 |
| | 0 second | 15 seconds | seconds | seconds |
| Range (atomic %) | 10 to 50 | 7 to 35 | 5 to 30 | 3 to 25 |
| Preferable range | 12 to 47 | 8 to 32 | 6 to 28 | 3 to 23 |
| | (e.g., 15 to 45) | (e.g., 10 to 30) | | |
| More preferable | 15 to 45 | 10 to 28 | 7 to 25 | 3 to 22 |
| range | (e.g., 17 to 45) | | | |

The typical member has the following carbon atomic concentration (atomic %).

Specifically, the carbon atomic concentrations (atomic %) of the member comprising an alumina are as follows.

TABLE 2
(Alumina)

| | Etching time | | | |
|---|---|---|---|---|
| | | 15 | | |
| | 0 second | seconds | 30 seconds | 60 seconds |
| Range (atomic %) | 15 to 50 | 7 to 35 | 5 to 27 | 3 to 25 |
| | (e.g., 17 to 48) | | | |
| Preferable range | 20 to 47 | 10 to 32 | 6 to 25 | 3 to 23 |
| | (e.g., 23 to 47) | | | |
| More preferable | 25 to 45 | 12 to 30 | 7 to 23 | 3 to 20 |
| range | | | (e.g., 10 | (e.g., 5 |
| | | | to 23) | to 20) |

The carbon atomic concentrations (atomic %) of the member comprising a quartz or a glass are as follows.

TABLE 3
(Quartz or Glass)

| | Etching time | | | |
|---|---|---|---|---|
| | 0 | | | 60 |
| | second | 15 seconds | 30 seconds | seconds |
| Range (atomic %) | 10 to 50 | 8 to 35 | 7 to 30 | 6 to 25 |
| | | (e.g., 10 to 33) | (e.g., 10 to 30) | |
| Preferable range | 15 to 45 | 12 to 32 | 10 to 28 | 8 to 23 |
| | (e.g., 17 | (e.g., 10 to 30) | | |
| | to 42) | | | |
| More preferable | 18 to 42 | 13 to 30 | 12 to 25 | 10 to 22 |
| range | | | | (e.g., 10 |
| | | | | to 20) |

The carbon atomic concentrations (atomic %) of the member comprising an anodized aluminum are as follows.

TABLE 4
(Anodized aluminum)

| | Etching time | | | |
|---|---|---|---|---|
| | | | 30 | |
| | 0 second | 15 seconds | seconds | 60 seconds |
| Range (atomic %) | 20 to 40 | 12 to 30 | 10 to 25 | 5 to 20 |
| | | | | (e.g., 6 to 20) |
| Preferable range | 22 to 37 | 14 to 27 | 12 to 23 | 10 to 20 |
| | | (e.g., 15 to 25) | | |
| More preferable | 25 to 35 | 18 to 25 | 15 to 20 | 10 to 16 |
| range | | | | (e.g., 10 to 15) |

(2) Oxygen Atomic Concentration (Atomic %)

The oxygen atomic concentrations (atomic %) of the member comprising a ceramic (e.g., an oxide ceramic) or an alumite are as follows.

TABLE 5

| | Etching time | | | |
|---|---|---|---|---|
| | | | 30 | |
| | 0 second | 15 seconds | seconds | 60 seconds |
| Range (atomic %) | 30 to 60 | 35 to 62 | 43 to 63 | 45 to 65 |
| | | (e.g., 40 to 60) | (e.g., 45 | (e.g., 50 to 62) |
| | | | to 60) | |
| Preferable range | 32 to 58 | 40 to 60 | 42 to 60 | 45 to 62 |
| | | (e.g., 42 to 59) | | (e.g., 50 to 60) |
| More preferable | 33 to 57 | 42 to 58 | 45 to 59 | 50 to 60 |
| range | (e.g., 35 | | | |
| | to 55) | | | |

The typical member has the following oxygen atomic concentration (atomic %).

Specifically, the oxygen atomic concentrations (atomic %) of the member comprising an alumina are as follows.

TABLE 6
(Alumina)

| | Etching time | | | |
|---|---|---|---|---|
| | | | 30 | 60 |
| | 0 second | 15 seconds | seconds | seconds |
| Range (atomic %) | 30 to 55 | 35 to 57 | 43 to 63 | 45 to 62 |
| | (e.g., 32 to 52) | (e.g., 40 to 55) | (e.g., 43 | (e.g., 48 |
| | | | to 60) | to 60) |
| Preferable range | 32 to 50 | 40 to 55 | 42 to 60 | 45 to 59 |
| | (e.g., 33 to 47) | | | |
| More preferable | 34 to 47 | 42 to 53 | 45 to 57 | 50 to 58 |
| range | (e.g., 35 to 45) | | | |

The oxygen atomic concentrations (atomic %) of the member comprising a quartz or a glass are as follows.

TABLE 7
(Quartz or Glass)

| | Etching time | | | |
|---|---|---|---|---|
| | | | | 60 |
| | 0 second | 15 seconds | 30 seconds | seconds |
| Range (atomic %) | 30 to 60 | 35 to 62 | 40 to 63 | 45 to 63 |
| | (e.g., 33 to 58) | | (e.g., 43 | |
| | | | to 60) | |
| Preferable range | 35 to 58 | 40 to 60 | 45 to 60 | 47 to 61 |
| | (e.g., 37 to 58) | | | |
| More preferable | 38 to 57 | 45 to 58 | 48 to 58 | 50 to 60 |
| range | (e.g., 40 to 55) | | | |

The oxygen atomic concentrations (atomic %) of the member comprising an anodized aluminum are as follows.

TABLE 8
(Anodized aluminum)

| | Etching time | | | |
|---|---|---|---|---|
| | 0 second | 15 seconds | 30 seconds | 60 seconds |
| Range (atomic %) | 40 to 58 | 48 to 60 | 50 to 62 | 55 to 65 |
| Preferable range | 43 to 56 | 50 to 60 | 53 to 60 | 55 to 62 |
| More preferable | 46 to 55 | 52 to 58 | 55 to 59 | 58 to 60 |
| range | | (e.g., 53 | | |
| | | to 57) | | |

(B) Member Comprising a Metal (e.g., Silicon):

The oxygen atomic concentrations (atomic %) of the member comprising a metal (e.g., silicon) are as follows.

TABLE 9

| | Etching time | | | |
|---|---|---|---|---|
| | 0 second | 15 seconds | 30 seconds | 60 seconds |
| Range (atomic %) | 32 to 45% | 28 to 42% | 22 to 36% | 13 to 25% |
| Preferable range | 35 to 42% | 30 to 40% | 23 to 34% | 14 to 22% |
| More preferable | 37 to 40% | 32 to 38% | 24 to 32% | 16 to 20% |
| range | | | | |

That is, when the depth profile of the surface of the corrosion-resistant member of the present invention (the treated member comprising a metal such as silicon) is analyzed by the X-ray photo electron spectrum at an etching speed of 5 nm/min, the member has any one of the following oxygen atomic concentrations 32 to 45% at an etching time of 0 second; 28 to 42% at an etching time of 15 seconds; 22 to 36% at an etching time of 30 seconds; and 13 to 25% at an etching time of 60 seconds.

Furthermore, compared with an untreated member, the reduction rate of the carbon atomic concentration of the member treated with the superheated water vapor (or the surface-modified member) is about 10 to 80% (for example, about 15 to 75%, more preferably about 17 to 70%) at an etching time of 0 second; about 15 to 90% (for example, about 20 to 85% and preferably 25 to 80%) at an etching time of 15 seconds; about 20 to 90% (for example, about 22 to 85% and preferably about 25 to 80%) at an etching time of 30 seconds; and 20 to 90% (for example, about 22 to 85% and preferably 25 to 80%) at an etching time of 60 seconds.

Comparing with an untreated member, the increase rate of the oxygen atomic concentration of the member treated with the superheated water vapor (or the surface-modified member) may be about 15 to 120% (for example, about 17 to 110% and preferably about 20 to 100%) at etching time of 0 second; 10 to 150% (for example, about 12 to 140%, preferably about 13 to 135%, and more preferably about 15 to 120%) at an etching time of 15 seconds; about 7 to 130% (for example, 8 to 120% and preferably about 10 to 110%) at an etching time of 30 seconds; and about 5 to 125% (for example, about 7 to 120%, preferably about 8 to 110%, and more preferably about 10 to 100%) at an etching time of 60 seconds.

That is, the corrosion-resistant member of the present invention (treated member comprising a ceramic or an alumite) has any one of the following reduction rates of the carbon atomic concentration: 10 to 80% at an etching time of 0 second; 15 to 90% at an etching time of 15 seconds; 20 to 90% at an etching time of 30 seconds; and 20 to 90% at an etching time of 60 seconds; and any one of the following increase rates of the oxygen atomic concentration: 15 to 120% at an etching time of 0 second; 10 to 150% at an etching time of 15 seconds; 7 to 130% at an etching time of 30 seconds; and 5 to 125% at an etching time of 60 seconds, compared with an untreated member, when the depth profile of the surface of the member is analyzed by the X-ray photo electron spectrum analysis at an etching speed of 5 nm/min.

It is sufficient that the corrosion-resistant member (surface-modified member) of the present invention shows the carbon atomic concentration and the reduction rate of the carbon atomic concentration or the oxygen atomic concentration and the increase rate of the oxygen atomic concentration at any one of the etching times. The surface-modified member of the present invention may satisfy the atomic concentrations, and the reduction and the increase rates at all of the etching times or at a plurality of the etching times (for example, at 0 second, 13 seconds, and 30 seconds).

### INDUSTRIAL APPLICABILITY

As described above, the surface-treatment with the superheated water vapor can improve or enhance the corrosion resistance, plasma resistance, and hydrophilicity of the untreated member and effectively prevent the adhesion of the contaminants to the treated member (the obtained member). Accordingly, the present invention is applicable to various applications or fields and useful to treat, particularly, a member constituting the processing unit (e.g., a chamber or a reactor) of the surface process apparatus utilizing the vapor phase method (such as an apparatus utilizing a PVD, a CVD, an ion-beam mixing, an etching, or an impurity doping). In addition, the use of the surface-modified member for the surface process apparatus (e.g., a vacuum camber of a plasma apparatus) prevents an accumulation of contaminants on the member, so that an abnormal discharge can be avoided and the frequency of the maintenance work of the member can be reduced.

### EXAMPLES

Hereinafter, the following examples are intended to describe this invention in further detail and should by no means be interpreted as defining the scope of the invention.

### Example 1 and Comparative Example 1

A polished surface (MFA surface) of a quartz glass plate (250 mm×250 mm×5 mm) was sprayed with a superheated water vapor (the temperature at a nozzle was 470° C. and the flow rate was 60 kg/h) for 30 minutes to produce a corrosion-resistant (surface-treated or surface-modified) plate of Example 1. Incidentally, the temperature measured at or on the surface being treated (the surface) was 420° C. The same quartz glass plate as the plate used in Example 1 was used, without a superheated water vapor treatment, as an untreated plate of Comparative Example 1.

### Example 2 and Comparative Example 2

Except for spraying a surface polished with a #320 sandpaper of a quartz glass plate (250 mm×250 mm×5 mm) with a spray of a superheated water vapor (the temperature at a nozzle was 470° C. and the flow rate was 60 kg/h) for 30 minutes, a corrosion-resistant plate was obtained by using the same manner as in Example 1. Incidentally, the temperature measured at or on the surface being treated (a surface) of the quarts glass plate was 420° C. The same quartz glass plate as the plate used in Example 2 was used, without a super heated water vapor treatment, as an untreated plate of Comparative Example 2.

### Example 3 and Comparative Example 3

An aluminum plate A6061 (aluminum-magnesium-silicon alloy) (an upper electrode of a dry etching apparatus having a length of 250 mm, a width of 250 mm, and a thickness of 12 mm) was subjected to a surface-treatment with a superheated water vapor (the temperature at a nozzle was 470° C. and the flow rate was 60 kg/h) for 20 minutes to produce a corrosion-resistant plate of Example 3. Incidentally, the aluminum plate A6061 was an aluminum plate had been subjected to anodization with sulfuric acid (hard-anodization) to form a large number of micropores at an interval of 25 mm in lengthwise and crosswise directions and to a sealing, and each micropore comprised a first pore having a mean pore diameter of 2 mm and a pore depth of 9 mm and a second pore formed from the bottom of the first pore and having a mean pore diameter of 0.5 mm and a pore depth of 3 mm. The temperature measured at or on the surface being treated (the surface) of the aluminum plate was 412° C. The same aluminum plate as the plate used in Example 3 was used, without a superheated water vapor treatment, as an untreated plate of Comparative Example 3.

Then the wettabilities of the treated surfaces of the members of Examples and the untreated surfaces of Comparative Examples were measured, under the condition of a temperature of 20° C. and a humidity of 60% RH, in accordance with JIS K6768.

In addition, a polyimide film having a hole (having a diameter of 6 mm) (manufactured by DuPont, Kapton (registered trademark)) was laminated on each of the quartz glass plates and 15% hydrofluoric acid was dropped on the surfaces of the plates. After allowing the plate to stand for 16 minutes at 20° C., the plates were washed and the elution amounts (amount of reduction in weight) of the plates were measured. Moreover, the aluminum plates of Example 3 and Comparative Example 3 were laminated with a polyimide film having a hole or pore (having a diameter of 6 mm) (manufactured by DuPont, Kapton (registered trademark)). A drop of 35% concentrated hydrochloric acid was placed on an exposed circular area of the plates. The amount of time for generating a bubble on or from the plate was measured at 20° C.

The results are shown in Table 10.

TABLE 10

| | | Acid resistance | |
|---|---|---|---|
| | | 15% Hydrofluoric | |
| | | acid (amount of | 35% Concentrated |
| | | reduction in | hydrochloric acid |
| | Wettability | weight) | (minute) |
| Ex. 1 | 37 | 0.08 g | — |
| Com Ex. 1 | 30 | 0.10 g | — |
| Ex. 2 | 40 | 0.08 g | — |
| Com Ex. 2 | 38 | 0.10 g | — |
| Ex. 3 | 38 | — | 130 minutes |
| Com Ex. 3 | 33 | — | 75 minutes |

Furthermore, the aluminum plates which had been subjected to anodization of Example 3 and Comparative Example 3 were observed with an electron microscope (1000 magnifications). The observation of Example 3 revealed that the surface of the plate was almost free from the adhesion of particle. Meanwhile, the observation of Comparative Example 3 revealed that the surface of the plate had a large number of particles thereon.

Moreover, the surfaces of the aluminum plates which had been subjected to anodization of Example 3 and Comparative Example 3 were marked with four kinds of marking pens [a red marking pen (an oil-based permanent marker manufactured by Pentel Co., Ltd., brand name “PENTEL PEN N50”), a black marking pen (a water-based marker manufactured by Mitsubishi Pencil Co., Ltd., brand name “uni PROCKEY PM-150TR”), a blue marking pen (a crayon manufactured by Kokuyo Co., Ltd.), and a peach color marking pen (an oil-based dye manufactured by Kohzai Corporation, brand name “Micro check No. 2”)]. The marked plates were subjected to an ultrasonic cleaning in a pure water (an ultrasonic cleaning tank having a power output of 600 W and a frequency of 27 kHz, the liquid temperature: 30° C., and the manner of cleaning: hooking the sample to a jig to hold the sample) and an ultrasonic cleaning in trichloroethylene (an ultrasonic cleaning tank having a power output of 600 W and a frequency of 27 kHz, the liquid temperature: a room temperature, the value of resistance: not less than 4 MΩ, and the manner of cleaning: holding the sample by hand).

After subjecting the aluminum plate of Example 3 to the ultrasonic cleaning in a pure water for 15 minutes, the peach color maker was completely washed away from the surface of the plate, the blue maker was almost washed away therefrom, and the red and black makers were partly washed away therefrom. On the other hand, after subjecting the aluminum plate of Comparative Example 3 to the ultrasonic cleaning in a pure water for 15 minutes, the peach color maker was completely washed away from the plate surface. However, the blue and red makers were only partly washed away therefrom, and black maker was hardly washed away therefrom.

After the aluminum plate of Example 3 was subjected to the ultrasonic cleaning in trichloroethylene for 15 minutes, the peach color and red makers were completely washed away from the plate surface, the blue maker was almost washed away therefrom, and the black maker was partly washed away therefrom. Whereas after the aluminum plate of Comparative Example 3 was subjected to the ultrasonic cleaning in trichloroethylene for 15 minutes, the peach color and red makers were completely washed away from the plate surface. However, the blue maker was only partly washed away from the plate surface, and black maker was hardly washed away therefrom.

### Example 4 and Comparative Example 4

An aluminum plate A5052 (aluminum-magnesium alloy) which had been subjected to an anodization (hard-anodization) and a sealing was subjected to a surface-treatment with a spray of a superheated water vapor (the temperature at a nozzle was 410° C. and the flow rate was 60 kg/h) for 20 minutes to produce a corrosion-resistant plate of Example 4. The temperature measured at or on a surface being treated (a surface) of the aluminum plate was 155° C. The same aluminum plate as the plate used in Example 4 was used, without a superheated water vapor treatment, as an untreated plate of Comparative Example 4.

Using the same procedure as in Examples 1 to 3, a drop of 35% concentrated hydrochloric acid was placed on the surfaces of the aluminum plates of Example 4 and Comparative Example 4. The amount of time for generating a bubble was measured at 20° C.

The results are shown in Table 11. Incidentally, in Table 11, the symbol “A” represents that the plate surface was unchanged, and the symbol “B” represents a generation of a bubble on or from the plate surface.

TABLE 11

| Elapsed time | | Comparative |
|---|---|---|
| after dropping | Example 4 | Example 4 |
| 10 minutes | A | A |
| 30 minutes | A | A |
| 45 minutes | A | B |
| 75 minutes | B | B |

As apparent from Table 11, even at 45 minutes after dropping the concentrated hydrochloric acid, a bubble was not generated on or from the plate comprising an aluminum-magnesium alloy of Example 4 and surface-treated. Meanwhile, at 45 minutes after dropping the concentrated hydrochloric acid, a bubble was generated on the untreated plate of Comparative Example 4. In addition, at 75 minute after dropping the concentrated hydrochloric acid, the amount of bubble generated on or from the plate of Comparative Example 4 was greater than that generated on or from the plate of Example 4.

### Example 5 and Comparative Example 5

An aluminum plate (A5052) having an anodized aluminum layer (having a thickness of 50 μm) formed by an anodization (a hard anodization) and a sealing was subjected to a surface-treatment with a spray of a superheated water vapor (the temperature at a nozzle was 410° C. and the flow rate was 60 kg/h) for 15 minutes to produce a corrosion-resistant plate of Example 5. The same aluminum plate as the plate used in Example 5 was used, without a superheated water vapor treatment, as an untreated plate of Comparative Example 5.

Using a vacuum chamber for dry etching (manufactured by Tokyo Electron Ltd., “Telius”), each of the plates was subjected to an irradiation with a plasma generated from a reactive gas, at a pressure of 4 Pa (30 mTorr) for two hours. The reactive gas was a mixed gas containing tetrafluoromethane, oxygen, and argon (tetrafluoromethane/oxygen/argon (volume ratio)=16/4/80). After the irradiation, the thickness of the anodized aluminum layer of each plate was determined. The determination of the thickness was repeated twice.

From the obtained thickness of the anodized aluminum layer after the irradiation, the damaged thickness (or reduced thickness) of the anodized aluminum layer due to plasma irradiation to the anodized aluminum layer was calculated. In addition, the reduced thickness (or damaged thickness) was determined as follows: 1) prior to the etching covering the four corners of the plate with a film; 2) after the glass substrate etching, removing the film from the corners; 3) measuring the thicknesses of the anodized aluminum layer at an area that had been covered with the film and at an area that had been irradiated with the plasma, using a laser microscope manufactured by Olympas Corporation, and calculating the difference in the thickness between the two areas.

The results are shown in Table 12. In Table 12, the term “average” represents the average of the values in the first and second measurements.

TABLE 12

| | | | Comparative |
|---|---|---|---|
| | | Example 5 | Example 5 |
| Damaged | First | 20.33 μm | 26.77 μm |
| thickness of | Second | 20.79 μm | 27.72 μm |
| anodized | Average value | 20.56 μm | 27.25 μm |
| aluminum | | | |
| layer | | | |

As apparent from Table 12, the wear-out (or reduction) due to the plasma irradiation to the anodized aluminum layer of the surface-treated plate of Example was as much as about 7 μm smaller than that of the untreated plate of Comparative Example. The improvement in plasma resistance was about 25%.

1. A corrosion-resistant member, which comprises an inorganic substance and has a corrosion-resistance improved by a surface-modification, wherein the member has an acid resistance and a plasma resistance.

2. A corrosion-resistant member according to claim 1, which has an index of wettability of 35 to 45, measured in accordance with JIS K6768, and the index of wettability is 2 to 10 greater than that of an untreated member.

3. A corrosion-resistant member according to claim 1, which has an index of wettability of 36 to 43.

4. A corrosion-resistant member according to claim 1,
which comprises an aluminum-magnesium alloy, and when 35% hydrochloric acid is dropped on a surface of the corrosion-resistant member, it takes not less than 45 minutes to generate a bubble at a room temperature; or
which comprises an aluminum-magnesium-silicon alloy, and when 35% hydrochloric acid is dropped on a surface of the corrosion-resistant member, it takes not less than 75 minutes to generate a bubble at a room temperature.

5. A corrosion-resistant member according to claim 1, which has a resistance to a plasma generated from at least one selected from the group consisting of a rare gas, hydrogen, a nitrogen-containing gas, an oxygen-containing gas, a hydrocarbon, and a halogen-containing gas.

6. A corrosion-resistant member according to claim 1, which has a resistant to a plasma generated from a halogen-containing gas.

7. A corrosion-resistant member according to claim 1, which comprises at least one selected from the group consisting of a ceramic and a metal.

8. A corrosion-resistant member according to claim 1, which comprises an oxide ceramic, an oxidized metal, or a metal, wherein the oxide ceramic, the oxidized metal, or the metal comprises at least one element selected from the group consisting of an element of the Group 3 of the Periodic Table of Elements, an element of the Group 4 of the Periodic Table of Elements, an element of the Group 5 of the Periodic Table of Elements, an element of the Group 13 of the Periodic Table of Elements, and an element of the Group 14 of the Periodic Table of Elements.

9. A corrosion-resistant member according to claim 1, which comprises an oxide ceramic, an oxidized metal, or a metal, wherein the oxide ceramic, the oxidized metal or the metal comprises at least one element selected from the group consisting of yttrium, silicon, and aluminum.

10. A corrosion-resistant member according to claim 1, which comprises at least one selected from the group consisting of an yttria, a silica or a glass, an alumina, an anodized aluminum or an alloy thereof, silicon, and aluminum or an alloy thereof.

11. A corrosion-resistant member according to claim 1, which is a member contactable with a processing space in a surface process apparatus utilizing a vapor phase method; a constituting member for an inlet or exhaust duct or canal of the surface process apparatus; a transparent protective member; an optical member; or a pipe for transferring a fluid.

12. A corrosion-resistant member according to claim 1, which is a member constituting at least an inner surface of a surface process apparatus utilizing a vapor phase method or a member disposed in the surface process apparatus.

13. A corrosion-resistant member according to claim 1, which is a base material or a substrate to be processed by a vapor phase method; or at least one selected from the group consisting of a transport jig, an electrode member, a holder or a supporter, a boat, a covering member, an insulator, a constituting member for an inlet or an exhaust duct or a constituting member for a channel, an inner wall or an interior member, a plate, and a joining or a fixing member.

14. A corrosion-resistant member according to claim 1, which is a member constituting an observation window for observing the inside of a vapor phase-surface process apparatus or a member having a pore through which an etching gas can pass.

15. A corrosion-resistant member according to claim 11, wherein the vapor phase method comprises a physical vapor deposition, a chemical vapor deposition, an ion beam mixing technique, an etching technique, or an impurity doping technique.

16. A corrosion-resistant member according to claim 11, which has an anodized layer and a damaged thickness of the anodized layer is 3 to 25 μm when the corrosion-resistant member is irradiated with a plasma generated from a mixed gas containing tetrafluoromethane, oxygen, and argon in a volume ratio of 16/4/80 for two hours at a degree of vacuum of 4 Pa using a plasma surface process apparatus.

17. A process for producing a corrosion-resistant member having an acid resistance and a plasma resistance, which comprises treating an untreated member with a superheated water vapor, wherein the untreated member is selected from the group constituting of a ceramic and a metal.

18. A process according to claim 17, wherein the untreated member is treated with the superheated water vapor having a temperature of 300 to 1000° C.

19. A process according to claim 17, wherein the untreated member is treated with a superheated water vapor of 0.1 to 100 kg/h in terms of water vapor relative to 1 m² of a surface area of the member.

20. A surface-treatment process for improving an acid resistance and plasma resistance of a member, which comprises treating the member with a superheated water vapor, wherein the member comprises at least one selected from the group constituting of a ceramic and a metal.
